(19) United States
(12) Patent Application Publication
(10) Pub. No.: US 2011/0134773 A1
(43) Pub. Date: Jun. 9, 2011

(54) METHOD AND APPARATUS FOR ESTIMATING PROPAGATION DELAY TIME

(75) Inventor: Dong Kyoo KIM, Chungcheongnam-do (KR)

(73) Assignee: Electronics and Telecommunications Research Institute, Daejeon (KR)

(21) Appl. No.: 12/939,756

(22) Filed: Nov. 4, 2010

(30) Foreign Application Priority Data
Dec. 4, 2009 (KR) 10-2009-0119962
Mar. 17, 2010 (KR) 10-2010-0023775

(51) Int. Cl. H04L 12/26

(52) U.S. Cl. 370/252

(57) ABSTRACT

An apparatus for estimating a propagation delay time using signal transmission/reception receives an initial reception signal or a signal of which frequency offset is compensated to correspond to a predetermined condition and detects a peak time of a received signal. Next, the propagation delay time estimating apparatus estimates and compensates frequency offset of the signal of which the peak time is detected and redetects the peak time of the received signal of which the frequency offset is compensated to compensate the peak time of the received signal.

### CROSS-REFERENCE TO RELATED APPLICATION

This application claims priority to and the benefit of Korean Patent Application Nos. 10-2009-0119962 and 10-2010-0023775 filed in the Korean Intellectual Property Office on Dec. 4, 2009 and Mar. 17, 2010, the entire contents of which are incorporated herein by reference.

### BACKGROUND OF THE INVENTION

(a) Field of the Invention

The present invention relates a method and an apparatus for estimating a propagation delay time. More particularly, the present invention relates to a method and an apparatus for estimating a propagation delay time of a wireless LAN signal.

(b) Description of the Related Art

A ranging method based on a wireless LAN (hereinafter, referred to as “WLAN”) uses received signal strength (hereinafter, referred to as “RSS”), angle of arrival (hereinafter, referred to as “AoA”), and round trip time (hereinafter, referred to as “RTT”) of a signal.

The ranging method using the RSS is a method to estimate a propagation distance by an attenuation level of a signal generated by propagating a received signal through a medium. This method uses a signal attenuation value, a pattern of the signal attenuation value, etc.

The ranging method using the AoA is a method to estimate a location to which the signal is transmitted by measuring an incident angle of a signal received into an antenna and thus analyzing a propagation path of the signal. Further, the ranging method using the AoA has a disadvantage in deteriorating in precision under an environment of severe multipaths.

The ranging method using the RTT is generally used in a global positioning system (GPS), IEEE 802.15.4a, etc. The ranging method using the RTT is a method in which an initiator or responder measures a time from when the responder receives/senses a signal which the initiator transmits to the responder to when the initiator receives/senses a signal which the responder transmits to the initiator. At this time, a distance between the initiator and the responder can be acquired by multiplying the measured RTT by a propagation velocity.

Herein, elements for determining RTT measurement precision include waveform characteristics of the signal, propagation characteristics of the signal, time precision of a measurement apparatus, etc.

Since a WLAN system is primarily used in indoor space, the propagation characteristics of the signal include characteristics of an indoor channel. The time precision in the WLAN system is described to have a value of a standard value±20 ppm to the minimum.

The waveform characteristics of the signal in the WLAN system have the following features.

Signal characteristics of a symbol described in the orthogonal frequency division multiplexing-physical (OFDM-PHY) of IEEE 802.11 have square wave characteristics. PHY adopting a direct sequence spread spectrum (DSSS) corresponding to single-carrier PHY has SYNC waveform characteristics, but the OFDM-PHY has simple square wave characteristics, such that resolution in a time domain is deteriorated.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and an apparatus for estimating a propagation delay time having advantages of improving resolution in a time domain by changing characteristics of a preamble signal and preventing the resolution in the time domain from being deteriorated by frequency offset.

An exemplary embodiment of the present invention provides a method for estimating a propagation delay time using signal transmission/reception that includes:

receiving an initial reception signal or a signal of which frequency offset is compensated according to a predetermined condition; detecting a peak time of a received signal; estimating frequency offset of the signal from which the peak time is detected; compensating the frequency offset of the signal from which the peak time is detected; and compensating the peak time of the received signal by redetecting the peak time of the received signal of which the frequency offset is compensated.

Another embodiment of the present invention provides an apparatus for estimating a propagation delay time by using signal transmission/reception that includes:

a coarse/fine switch for outputting an initial reception signal or a signal of which frequency offset is compensated to correspond to a predetermined condition; a peak detector for detecting an initial peak time of the initial reception signal or a peak time of the signal of which the frequency offset is compensated; an estimator for estimating frequency offset of the signal from which the peak time is detected; and a compensator for compensating the frequency offset of the signal of which is the peak time is detected.

### BRIEF DESCRIPTION OF THE DRAWINGS

FIG. 1 is a diagram showing a method of measuring RTT on the basis of a preamble signal waveform according to an exemplary embodiment of the present invention;

FIG. 2 is a diagram showing a preamble signal waveform according to an exemplary embodiment of the present invention;

FIG. 3 is a diagram schematically showing an apparatus for estimating a propagation delay time according to an exemplary embodiment of the present invention;

FIG. 4 is a diagram showing a pulse filter according to an exemplary embodiment of the present invention;

FIG. 5 is a diagram showing a peak detector according to an exemplary embodiment of the present invention;

FIG. 6 is a diagram showing an estimator and a compensator according to an exemplary embodiment of the present invention;

FIG. 7 is a diagram showing a coarse/fine switch according to an exemplary embodiment of the present invention; and

FIG. 8 is a flowchart showing a method for estimating a propagation delay time according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising”, will be understood to imply the inclusion of stated elements but not the exclusion of any other elements.

Hereinafter, a method and an apparatus for estimating a propagation delay time according to an exemplary embodiment of the present invention will be described in detail with reference to the accompanying drawings.

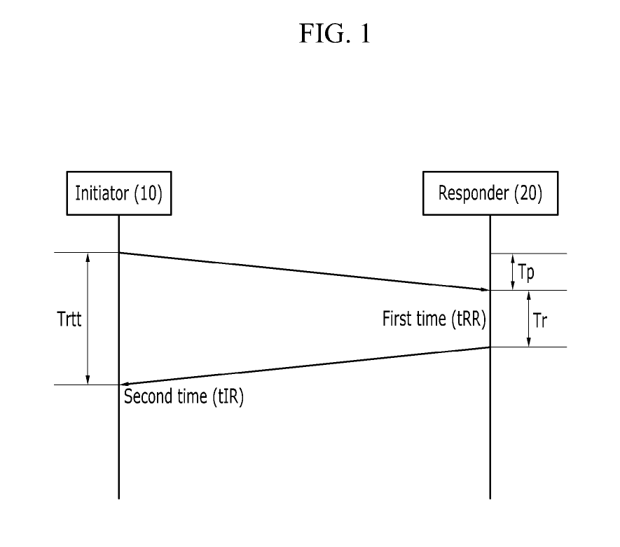

FIG. 1 is a diagram showing a method of measuring RTT on the basis of a preamble signal waveform according to an exemplary embodiment of the present invention.

First, a WLAN apparatus includes an initiator 10 and a responder 20 and may transmit and receive a preamble signal between the initiator 10 and the responder 20.

Referring to FIG. 1, a propagation delay time estimating apparatus measures a round trip time (hereinafter, referred to as “RTT”) by using signal transmission/reception between the initiator 10 and the responder 20.

Specifically, the initiator 10 transmits a preamble to the responder 20. Next, the responder 20 receives the preamble at a first time tRR and transmits a response signal corresponding to the received preamble to the initiator 10. The initiator 10 receives the response signal transmitted from the responder 20 at a second time tlR.

RTT(Tᵣₜₜ) measured by the propagation delay time estimating apparatus is shown in Equation 1.

Tₚ=0.5*(Tᵣₜₜ−Tᵣ) (Equation 1)

Where, Tₚ is a time from when the initiator 10 transmits the preamble to the responder 20 to when the preamble reaches the responder 20 and Tᵣ is a time from when the responder 20 receives the preamble to when the responder 20 starts to transmit the response signal to the initiator 10.

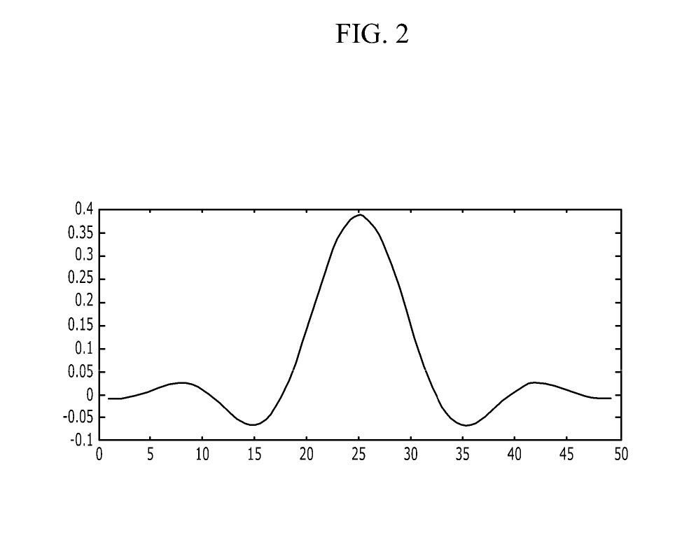

The propagation delay time estimating apparatus according to the exemplary embodiment of the present invention measures a reception time of the signal on the basis of a symbol signal waveform of the preamble. Herein, the signal waveform s(t) corresponds to a waveform of a square-root raised cosine (SRRC) signal and is shown in Equation 2.

$$s ( t ) = \frac{sin ( π t / {T}_{s} ( 1 - β ) + 4 βt / {T}_{s} cos ( π t / {T}_{s} ( 1 + β ) )}{π t / {T}_{s} ( 1 - {( 4 β t / {T}_{s} )}^{2} )} \qquad ( Equation 2 )$$

Where, Tₛ and β are a sampling time and a roll-off vector, respectively. Further, the range of β is 0=β=1. For example, a signal waveform when β is 0.3 is shown in FIG. 2.

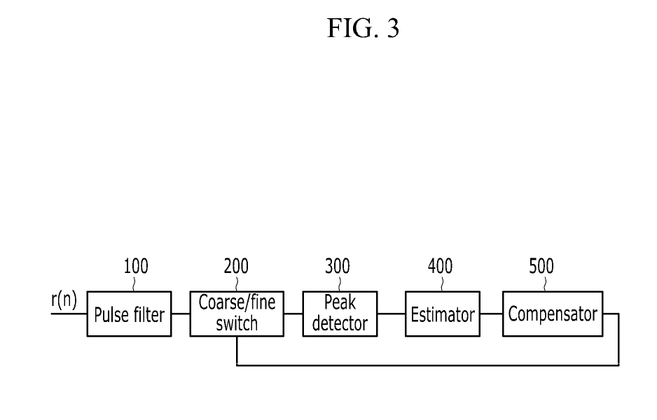

Next, the propagation delay time estimating apparatus according to the exemplary embodiment of the present invention will be described in detail with reference to FIG. 3.

FIG. 3 is a diagram schematically showing an apparatus for estimating a propagation delay time according to an exemplary embodiment of the present invention.

Referring to FIG. 3, the propagation delay time estimating apparatus includes a pulse filter 100, a coarse/fine switch 200, a peak detector 300, an estimator 400, and a compensator 500.

The pulse filter 100 includes a finite impulse response (FIR) filter having a coefficient shown in Equation 2.

The coarse/fine switch 200 selects an output to correspond to a predetermined condition, that is, a setting condition. Herein, the output of the coarse/fine switch 200 may be an output of the pulse filter 100 or an output of the compensator 500.

The peak detector 300 detects an output of the coarse/fine switch 200, that is, an initial peak time of a received signal or detects a peak time of a signal having compensated frequency offset.

The estimator 400 estimates frequency offset of the received signal.

The compensator 500 compensates the frequency offset of the received signal.

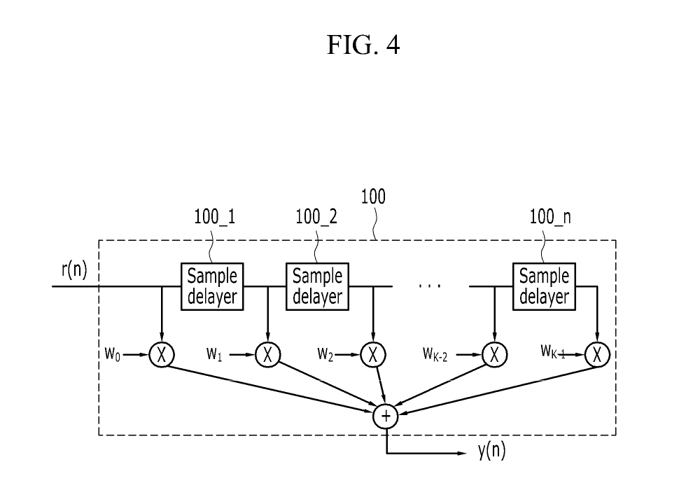

Next, the pulse filter 100 in the propagation delay time estimating apparatus according to the exemplary embodiment of the present invention will be described in detail with reference to FIG. 4.

FIG. 4 is a diagram showing a pulse filter according to an exemplary embodiment of the present invention.

Referring to FIG. 4, the pulse filter 100 includes a plurality of sample delayers 110_1 to 110_{—}n.

The pulse filter 100 receives a signal delayed through a prior sample delayer and delays the delayed signal for a predetermined time, which is outputted to a posterior sample delayer. Further, the pulse filter 100 generates signals W₀ to Wₖ₋₁ delayed by the plurality of sample delayers 110_1 to 110_{—}n into filter a coefficient y(n) through a predetermined procedure.

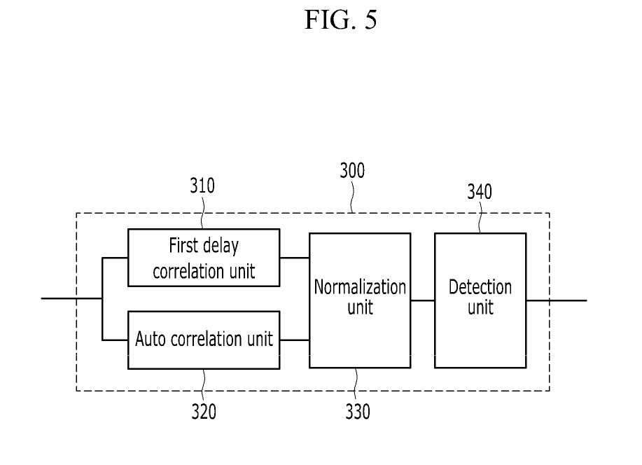

Next, the peak detector 300 in the propagation delay time estimating apparatus according to the exemplary embodiment of the present invention will be described in detail with reference to FIG. 5.

FIG. 5 is a diagram showing a peak detector according to an exemplary embodiment of the present invention.

First, the peak detector 300 detects an output of the coarse/fine switch 200, that is, an initial peak time of a received signal or detects a peak time of a signal having compensated frequency offset.

Referring to FIG. 5, the peak detector 300 includes a first delay correlation unit 310, an autocorrelation unit 320, a normalization unit 330, and a detection unit 340.

The first delay correlation unit 310 generates a first autocorrelation value y_{d&c}(n) corresponding to the received signal, i.e., the output of the coarse/fine switch 200. Herein, the first autocorrelation value is shown in Equation 3.

$${y}_{d \& c} ( n ) = {\sum }_{i = 0}^{N - 1} r ( n - i ) {r}^{*} ( n - i - d ) \qquad ( Equation 3 )$$

Where, n is a signal index, r is a received signal, d is a delay time, and N is an operation section.

According to a calculation result of Equation 3, i.e., the autocorrelation value, since distribution of a signal level is not uniform, signal detection may be difficult.

The autocorrelation unit 320 acquires an autocorrelation coefficient y_{ac}(n) of the received signal. According to the exemplary embodiment of the present invention, the autocorrelation coefficient corresponds to an energy level of the received signal. Herein, the autocorrelation coefficient is shown in Equation 4.

$${y}_{ac} ( n ) = {( {\sum }_{i = 0}^{N - 1} r ( n - i - d ) {r}^{*} ( n - i - d ) )}^{1 / 2} \qquad ( Equation 4 )$$

The normalization unit 330 normalizes the first autocorrelation value by using the autocorrelation coefficient to make distribution of an output level of an input signal r of the peak detector 300 uniformly. Herein, the normalization unit 330 performs normalization as shown in Equation 5.

yₙₒᵣₘ(n)=y_{d&c}(n)/y_{ac}(n) (Equation 5)

The detection unit 340 sets a threshold value a and detects a peak time corresponding to a detection condition in the operation section. Herein, the detection condition is shown in Equation 6.

yₚₑₐₖ=r(nₒ)={nₒ|nₒ=the smallest n among n of which yₙₒᵣₘ(n)>α} (Equation 6)

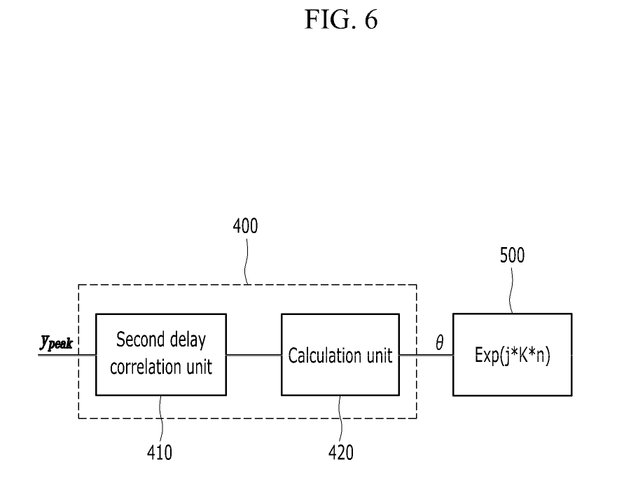

Next, the estimator 400 and the compensator 500 in the propagation delay time estimating apparatus according to the exemplary embodiment of the present invention will be described in detail with reference to FIG. 6.

FIG. 6 is a diagram showing an estimator and a compensator according to an exemplary embodiment of the present invention.

Referring to FIG. 6, the estimator 400 includes a second delay correlation unit 410 and a calculation unit 420.

The second delay correlation unit 410 generates an output of the peak detector 300, i.e., a second autocorrelation value corresponding to a signal yₚₑₐₖ of which the peak time is detected. Herein, the second autocorrelation value may be acquired as shown in Equation 3.

The calculation unit 420 estimates the frequency offset of the received signal by arc tangent (arctan)-operating the second autocorrelation value.

The compensator 500 compensates the frequency offset of the received signal by using a predetermined exponential function Exp(j*K*n). At this time, in the predetermined exponential function, K is shown using a sampling time Ts and an output θ of the calculation unit 420 as shown in Equation 7.

K=Tₛ×θ (Equation 7)

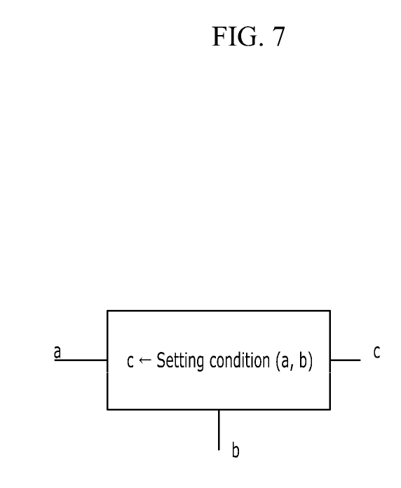

Next, the coarse/fine switch 200 in the propagation delay time estimating apparatus according to the exemplary embodiment of the present invention will be described in detail with reference to FIG. 7.

FIG. 7 is a diagram showing a coarse/fine switch according to an exemplary embodiment of the present invention.

Referring to FIG. 7, the coarse/fine switch 200 includes two input terminals a and b corresponding to the output of the pulse filter 100 or the output of the compensator 500 and an output terminal C corresponding to the input of the peak detector 300.

Specifically, the coarse/fine switch 200 selects an output of the output of the pulse filter 100 and the output of the compensator 500, which corresponds to the setting condition. Herein, the setting condition is as follows.

(1) An initial value of an input value of the peak detector 300 is set as the output of the pulse filter 100.

(2) The input value of the peak detector 300 is set as the output of the compensator 500 after a compensation time when the compensator 500 starts to compensate the frequency offset.

(3) When detection of a peak time of the signal having the compensated frequency offset after the compensation time is completed, the input value of the peak detector 300 is reset as the output of the pulse filter 100.

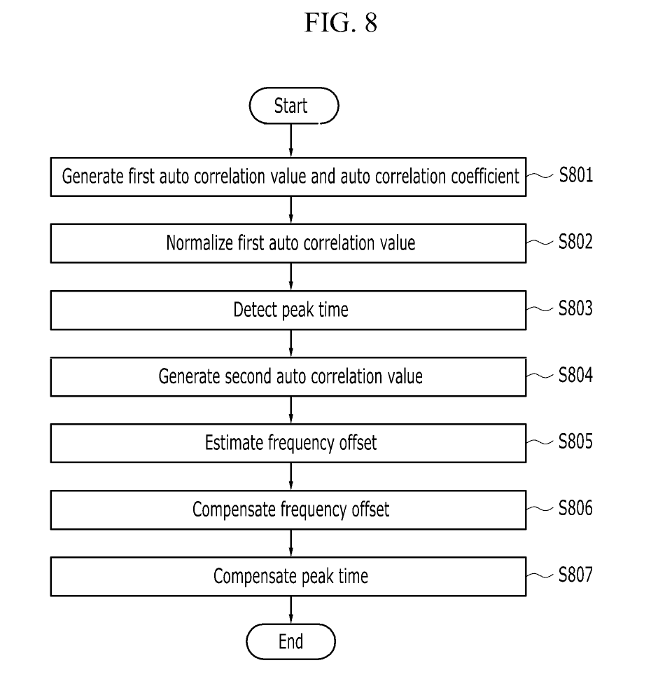

Next, a method for estimating a propagation delay time according to an exemplary embodiment of the present invention will be described in detail with reference to FIG. 8.

FIG. 8 is a flowchart showing a method for estimating a propagation delay time according to an exemplary embodiment of the present invention.

First, a propagation delay time estimating apparatus receives a preamble signal.

Referring to FIG. 8, the propagation delay time estimating apparatus generates the preamble signal, i.e., a first autocorrelation value corresponding to a received signal and an autocorrelation coefficient (S801).

The propagation delay time estimating apparatus normalizes the first autocorrelation value as shown in Equation 5 by using the autocorrelation coefficient (S802).

The propagation delay time estimating apparatus sets a threshold value of a normalized result value and detects a peak time corresponding to a setting condition in an operation section (S803). At this time, the corresponding setting condition sets an initial value of the received signal as an output of a pulse filter 100, i.e., a filter coefficient.

Next, the propagation delay time estimating apparatus generates a second autocorrelation value corresponding to a signal of which the peak time is detected (S804). Herein, the second autocorrelation value is shown in Equation 3. Further, the propagation delay time estimating apparatus estimates the frequency offset of the received signal by arc-tangent-operating the second autocorrelation value (S805).

The propagation delay time estimating apparatus compensates the frequency offset of the received signal by using a predetermined exponential function (S806).

The propagation delay time estimating apparatus compensates the peak time of the received signal by redetecting the peak time of the received signal having the compensated frequency offset (S807).

Accordingly, the propagation delay time estimating method according to the exemplary embodiment of the present invention can accurately estimate the round trip time by compensating the peak time of the received signal. Further, the method and apparatus for estimating a propagation delay time can improve ranging precision by more accurately measuring the peak time.

The above-mentioned exemplary embodiments of the present invention are not embodied only by an apparatus and method. Alternatively, the above-mentioned exemplary embodiments may be embodied by a program performing functions, which correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for estimating a propagation delay time using signal transmission/reception, comprising:
receiving an initial reception signal or a signal of which frequency offset is compensated according to a predetermined condition;
detecting a peak time of a received signal;
estimating frequency offset of the signal from which the peak time is detected;
compensating the frequency offset of the signal from which the peak time is detected; and
compensating the peak time of the received signal by redetecting the peak time of the received signal of which the frequency offset is compensated.

2. The method of claim 1, wherein:
the detecting a peak time includes
generating a first autocorrelation value corresponding to the received signal,
generating an autocorrelation coefficient corresponding to the received signal,
normalizing the first autocorrelation value by using the autocorrelation coefficient, and
detecting the peak time corresponding to a detection condition from a normalized result value.

3. The method of claim 2, wherein the detecting the peak time corresponding to a detection condition sets a threshold value for the normalized result value and detects the peak time in an operation section.

4. The method of claim 1, wherein:
the estimating frequency offset includes,
generating a second autocorrelation value corresponding to the signal of which the peak time is detected, and
compensating the frequency offset of the signal of which the peak time is detected by arc tangent-operating the second autocorrelation value.

5. The method of claim 1, wherein:
the compensating the frequency offset,
compensates the frequency offset of the signal of which the peak time is detected by using a predetermined exponential function.

6. The method of claim 1, wherein:
under the predetermined condition,
the signal of which the frequency offset is compensated is received after a compensation time when the frequency offset starts to be compensated, and
the initial reception signal is received when the signal is firstly received or the peak time of the signal of which of the frequency offset is compensated after the compensation time is detected.

7. An apparatus for estimating a propagation delay time by using signal transmission/reception, comprising:
a coarse/fine switch for outputting an initial reception signal or a signal of which frequency offset is compensated to correspond to a predetermined condition;
a peak detector for detecting an initial peak time of the initial reception signal or a peak time of the signal of which the frequency offset is compensated;
an estimator for estimating frequency offset of the signal from which the peak time is detected; and
a compensator for compensating the frequency offset of the signal of which is the peak time is detected.

8. The apparatus of claim 7, wherein:
under the predetermined condition,
an output value of the coarse/fine switch is set as the signal of which the frequency offset is compensated after a compensation time when the compensator starts to compensate the frequency offset, and
the output value of the coarse/fine switch is set as the initial reception signal when the coarse/fine switch firstly outputs the signal or the peak time of the signal of which the frequency offset is compensated after the compensation time is detected.

9. The apparatus of claim 7, wherein:
the peak detector includes,
a first delay correlation unit for generating a first auto correction value corresponding to the received signal,
an autocorrelation unit for generating an autocorrelation coefficient corresponding to the received signal
a normalization unit for normalizing the first autocorrelation value by using the autocorrelation coefficient, and
a detection unit for detecting the peak time corresponding to a detection condition from a normalized result value.

10. The apparatus of claim 9, wherein:
the detection unit
sets a threshold value of the normalized result value and detects the peak time corresponding to the detection condition in an operation section.

11. The apparatus of claim 7, wherein:
the estimator includes,
a second delay correlation unit generating a second autocorrelation value corresponding to the signal of which the peak time is detected, and
a calculation unit compensating the frequency offset of the signal of which the peak time is detected by arc tangent-operating the second autocorrelation value.

12. The apparatus of claim 7, wherein:
the compensator
compensates the frequency offset of the signal of which the peak time is detected by using a predetermined exponential function.

13. The apparatus of claim 7, further comprising:
a pulse filter including a plurality of sample delayers,
wherein the pulse filter
generates signals delayed by the plurality of sample delayers into a filter coefficient and outputs the initial reception signal including the filter coefficient to the coarse/fine switch.
